(19) United States
(12) Patent Application Publication
(10) Pub. No.: US 2010/0264162 A1
(43) Pub. Date: Oct. 21, 2010

(54) FUEL COMPOSITION DISPENSING SYSTEM

(75) Inventors: Ena Cratensburg, Orinda, CA (US); Rahul Shendure, Salt Lake City, UT (US)

Correspondence Address: JONES DAY, 222 EAST 41ST ST, NEW YORK, NY, 10017, US

(73) Assignee: Amyris Biotechnologies, Inc., Emeryville, CA (US)

(21) Appl. No.: 12/734,339

(22) PCT Filed: Oct. 24, 2008
(86) PCT No.: PCT/US2008/012107

§ 371 Date: Jun. 16, 2010

Related U.S. Application Data
(60) Provisional application No. 60/983,097, filed on Oct. 26, 2007.
(60) Provisional application No. 61/006,112, filed on Dec. 19, 2007.

(51) Int. Cl. B67D 7/04; B67D 7/74; B67D 7/70

(52) U.S. Cl. 222/1; 222/129; 222/135; 222/59; 222/71

(57) ABSTRACT

The invention provides methods and systems for selecting and blending conventional fuel components into fuel compositions using an input system and for supplying a selected fuel composition into a storage container. The methods and systems incorporate a mixer to mix at least one conventional petroleum-derived fuel component received from the conventional fuel component supply system with at least one second non-petroleum fuel component received from the second fuel component supply to form fuel compositions. The present invention provides for systems and methods of supplying selected blends of conventional petroleum fuel with a non-petroleum derived fuel to provide greater consumer accessibility for petroleum blended with alternative fuels.

### CROSS REFERENCE TO RELATED APPLICATIONS

This application claims the benefit of priority from U.S. Provisional Application No. 60/983,097, filed Oct. 26, 2007, and from U.S. Provisional Application No. 61/006,112, filed Dec. 19, 2007. These applications, in their entirety, are incorporated herein by reference.

### FIELD OF THE INVENTION

The invention relates to fuel composition dispensing systems and methods for supplying fuel compositions. In particular, the invention relates to fuel composition dispensing systems and methods where a customer selects a desired blend of a conventional fuel component and a second fuel component and the system supplies the selected desired blend to a vehicle or storage container of the purchaser.

### BACKGROUND OF THE INVENTION

Non-petroleum fuel alternatives have received considerable attention over the past few decades due to concerns over rising oil prices and impending supply constraints. These alternative fuels are typically blended with petroleum fuels so that the blended product can readily take advantage of existing fuel infrastructure. However, non-petroleum fuel alternatives are generally blended in fix amounts. For example, E85 and B5 fuels correspond to blends of 85% ethanol and 15% gasoline and of 5% fatty acid methyl ester and 95% diesel respectively. As a result, a consumer in general has little opportunity to buy petroleum fuel that is blended with various amounts of alternative fuels like ethanol, butanol, fatty acid methyl esters (also known as biodiesel), and Fisher-Tropsch fuels. A need exists for systems to supply selected blends of conventional petroleum fuel with a non-petroleum derived fuel. The present invention provides for such a system.

### SUMMARY OF THE INVENTION

Provided herein are systems and methods for dispensing fuel-compositions. In some embodiments, the invention provides a fuel composition-dispensing system and/or method that comprises a conventional fuel component and a second fuel component. A conventional fuel component is a petroleum derived fuel component and the second fuel component is a non-petroleum derived fuel component. In some embodiments, the fuel composition-dispensing systems and methods include selection of a fuel composition that is a blend of one or more conventional fuel components and one or more second fuel components by a purchaser at the point of sale. In some embodiments, the second fuel component is a C₁-C₂₀ alcohol. In certain embodiments, the second fuel is ethanol. In certain other embodiments, the second fuel is butanol. In some embodiments, the second fuel component is a biofuel. In contrast to non-renewable natural energy sources such as petroleum and coal, biofuels are derived from natural, renewable sources, typically from living or recently living organisms and their metabolic byproducts. In some embodiments, the biofuel is ethanol or butanol. In other embodiments, the biofuel is a fatty acid alkyl ester. In certain other embodiments, the biofuel is a fatty acid methyl ester (also known as biodiesel). In some embodiments, the biofuel is a bio-engineered fuel. In some embodiments, the biofuel is an isoprenoid compound or a combination of isoprenoids. In certain other embodiments, the biofuel is a C₁₅ isoprenoid compound or a combination of C₁₅ isoprenoid compounds. In another embodiment, the second fuel component is a Fisher-Tropsch fuel. In another embodiment, the second fuel component is a coal-derived fuel. In some embodiments, the conventional fuel component may be gasoline or petrodiesel and may be present in the fuel composition in an amount of from 99% to 1% by either volume or weight. In some embodiments, the second fuel component may be present in a fuel composition in an amount of from 1% to 99% by either volume or weight.

In some embodiments, the invention provides fuel composition-dispensing systems comprising one or more of the following: an input system, a blend control system, at least one fuel component supply system, at least one mixing system and at least one fuel composition supply system.

In some embodiments, the invention provides a fuel-composition dispensing system having at least one input system, at least one conventional fuel component supply system, at least one second fuel component supply system, and at least one mixer, where the mixer mixes at least one conventional fuel component received from the conventional fuel component supply system with at least one second fuel component received from the second fuel component supply system to form a fuel composition based on a blend selected using the input system.

In some embodiments, the second fuel component is a bio-engineered fuel component. In some embodiments, the second fuel component includes a C₁₅ isoprenoid compound, such as, for example a compound according to the following Formulas I and/or II:

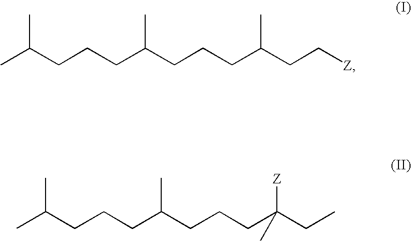

wherein Z is H, O—R, or O—C(═O)R; and R is H, alkyl, cycloalkyl, aryl, alkaryl or aralkyl. In certain embodiments, Z is H.

In some embodiments, the fuel composition, the conventional fuel component and/or the second fuel component further include one or more conventional fuel additives.

In some embodiments, the invention provides a method of supplying a fuel composition that includes receiving a selected fuel blend from a purchaser through an input system, the blend comprising at least one conventional fuel component and at least one second fuel component, receiving a demand for supply of a fuel composition based on the selected blend from a fuel composition supply system, controlling at least one conventional fuel component supply system and at least one second fuel component supply system to supply the at least one conventional fuel component and the at least one second fuel component to a mixer based on the selected blend, mixing the at least one conventional fuel component and the at least one second fuel component to form a fuel composition and supplying the fuel composition to a storage container, such as a gas tank of a vehicle such as a car, bus, truck, motorcycle or other vehicle.

### BRIEF DESCRIPTION OF THE DRAWINGS

FIG. 1 shows a block diagram of an embodiment of a fuel dispensing system.

FIG. 2 is a block diagram of an embodiment of an input system.

FIG. 3 is a block diagram of an embodiment of a blend control system.

FIG. 4 is a block diagram of an embodiment of a conventional fuel component supply system.

FIG. 5 is a block diagram of an embodiment of a second fuel component supply system.

FIG. 6 is a block diagram of an embodiment of a combined conventional and second fuel component supply system.

FIGS. 7A-C are block diagram of some embodiments of a mixing system.

FIG. 8 is a block diagram of an embodiment of a mixing system.

FIG. 9 shows the ASTM D 975 testing data for No. 2 diesel from the BP Whiting Refinery and 5%, 20% and 50% blends of farnesane with this fuel.

FIG. 10 shows the ASTM D 975 testing data for a diesel fuel from the BP Carson Refinery that meets the California Air Resources Board requirements (CARB fuel) and 5%, 20%, 50%, and 65% blends of farnesane. This particular sample of CARB fuel does not contain lubricity enhancers that are typically found in CARB fuel.

FIGS. 11A-B show the distillation profiles of No. 2 diesel and CARB diesel blended with various amounts of farnesane.

### DEFINITIONS

The ASTM D975 specifications, published by ASTM International, set certain minimum acceptance requirements for the different grades of diesel fuels used in the United States. For example, ultra low sulfur diesel fuel Grade No. 2-D is expected to have a maximum sulfur content of 0.05% by weight (under an ASTM D2622 test), a maximum ash content of 0.01% by weight (under an ASTM D482 test), a minimum cetane number of 40 (under an ASTM D6079 test), a viscosity at 40° C. of from 1.9 cSt to 2.4 cSt (under an ASTM 445 test), and a minimum flash point of 52° C. Japan and Europe have similar diesel fuel specifications to those of the United States for comparable grades of diesel fuels. For example, Japan's JIS K 2204, Grade No. 2 diesel fuel is expected to have a minimum viscosity at 40° C. of 2.0 cSt, a maximum sulfur content of 0.05% by weight, and a minimum cetane number of 45. By comparison, Europe's CEN 590, Grade A-F diesel fuel is expected to have a viscosity at 40° C. of from 2.0 cSt to 4.5 cSt, a maximum sulfur content of 0.05% by weight, and a minimum cetane number of 49. In some embodiments, the fuel compositions disclosed herein meet at least one or all of the above properties.

“Biodiesel” refers to the variety of diesel fuels derived from biological sources, such as vegetable oils or animal fats. Biodiesel is mainly a mixture of alkyl esters, including fatty acid methyl esters, derived from the transesterification of a mixture of the oils and methanol. While soybean oil is the largest source of biodiesel, oils from other plants or animal fats can be the source materials.

“Bioengineered fuel component” refers to a fuel component made at least in part by a host cell, including any archae, bacterial, or eukaryotic cells or microorganism.

“Biofuel” refers to any fuel that is derived from a biomass, i.e., recently living organisms or their metabolic byproducts, such as manure from cows. It is a renewable energy source, unlike other natural resources such as petroleum, coal and nuclear fuels.

“C₁₅ isoprenoid” or “C₁₅ isoprenoid compound” refers to an isoprenoid having 15 carbons.

“Conventional fuel component” refers to a petroleum-derived fuel. Illustrative examples of a conventional fuel component include but are not limited to gasoline, kerosene, jet fuel, and diesel fuel.

“Fuel component” refers to any compound or a mixture of compounds that are used to formulate a fuel composition (a fuel that comprises at least two fuel components). There are “major fuel components” and “minor fuel components.” A major fuel component is present in a fuel composition by at least 50% by volume; and a minor fuel component is present in a fuel composition by less than 50%.

“Isoprenoid” and “isoprenoid compound” are used interchangeably herein and refer to a compound that is capable of being derived from isopentenyl diphosphate (“IPP”).

“Petroleum-derived fuel” means a fuel that is derived from petroleum, such as a fractional distillate of petroleum.

“Second fuel component” refers to a non-petroleum-derived fuel, such as any fuel component that does not include a fractional distillate of petroleum or that is not derived from petroleum.

A composition that is a “substantially pure” compound refers to a composition that is substantially free of one or more other compounds, i.e., the composition contains greater than 80%, greater than 90%, greater than 95%, greater than 96%, greater than 97%, greater than 98%, greater than 99%, greater than 99.5%, greater than 99.6%, greater than 99.7%, greater than 99.8%, or greater than 99.9% of the compound; or less than 20%, less than 10%, less than 5%, less than 3%, less than 1%, less than 0.5%, less than 0.1%, or less than 0.01% of the one or more other compounds, based on the total volume or weight of the composition.

A composition that is “substantially free” of a compound refers to a composition containing less than 20%, less than 10%, less than 5%, less than 4%, less than 3%, less than 2%, less than 1%, less than 0.5%, less than 0.1%, or less than 0.01% of the compound, based on the total volume or weight of the composition.

In addition to the definitions above, certain compounds described herein have one or more double bonds that can exist as one or more stereoisomers such as cis-isomers, trans-isomers, E-isomers and Z-isomers. In certain embodiments, these compounds as individual stereoisomers are substantially free of other stereoisomers and alternatively, as mixtures of various stereoisomers.

In this description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

### DETAILED DESCRIPTION OF THE INVENTION

The invention provides fuel composition-dispensing pumps, and systems and methods for blending fuel components to form fuel compositions. In some embodiments, the fuel-dispensing pumps, systems and methods may be used to blend fuel components to form fuel compositions at the point of purchase. In some embodiments, the fuel composition-dispensing systems may comprise one or more of the following: an input system, a blend control system, at least one fuel component supply system, at least one mixing system and at least one fuel composition supply system and any combination thereof.

FIG. 1 shows a block diagram of an embodiment of a fuel composition-dispensing system 100. Fuel composition-dispensing system 100 has input system 110, display 120, blend control system 130, conventional fuel component supply system 140, second fuel component supply system 150, mixing system 160 and fuel composition supply system 170. A purchaser of the fuel composition may use input system 110 and display 120 to select a method of payment and select and provide payment information, to answer queries, and to select a desired blend of fuel components, all of which may be communicated to the blend control system 130. Blend control system 130 may control the blending of the fuel components, provide for authorization of the method of payment, calculate a blend price, interact with the purchaser via input system 110 and display 120 and may monitor, conduct and/or control the transaction. Blend control system 130 may control conventional fuel component supply system 140 and second fuel component supply system 150 to supply the fuel components in the appropriate proportions, based on the purchaser's selected blend, to mixing system 160. Mixing system 160 may mix the fuel components to form a fuel composition that is provided to the fuel composition supply system 170. Blend control system 130 initiates blending and supply of the fuel components upon actuation of fuel composition supply system 170 by the purchaser and may continue supplying the blend until the purchaser shuts off fuel composition supply system 170 or until an automatic shut off system is activated.

Input system 110 in conjunction with display 120 provides for interaction with the customer via one or more interactive options such as payment type selection, card or swipe fob input, pin or other security system entry and blend selection. Input system 110 may include any suitable input device or interactive device such as an alphanumeric keypad, a numeric keypad with one or more function keys such as “enter”, “yes”, “no” or other selector buttons, a touch screen, card reader, swipe reader such as a key fob reader, a series of selector buttons, a selection dial or any combination or one or more of the above. In some embodiments, a purchaser may select a payment type, scan a credit or debit card, enter a pin, if necessary, select a fuel blend or a desired set of fuel properties, verify or accept a price or estimated price for the fuel composition and/or conduct other transaction-related actions with prompts provided on display 120 at or before one or more of these steps to guide the customer through the input process. Display 120 may be any suitable display device, such as an LCD, LED or CRT display. Input system 110 may be a computerized system and may be implemented using or include one or more application specific integrated circuits (“ASICS”), one or more general integrated circuits, one or more commercial off the shelf systems, a combination of hardware and software suitable for performing its functions or may serve as a peripheral device or combination of peripheral devices controlled by the blend control system 130 or may be a combination of any of the above.

Blend control system 130 interacts with conventional fuel component supply system 140 and second fuel component supply system 150 to supply the individual fuel components in accordance with the purchaser-selected desired blend to the mixing system 160. Mixing system 160 mixes the conventional and second fuel components supplied from their respective supply systems 140 and 150 to form the fuel composition comprising the selected blend of fuel components and to supply the fuel composition to the fuel composition supply system 170. Fuel composition supply system 170 may be actuated by the purchaser or a technician to initiate the blending of the fuel components and to supply the fuel composition to a storage container, such as to a gas tank of a vehicle such as a car, bus, truck, motorcycle, airplane, jet airplane or other vehicle. Upon actuation of the fuel composition supply system, the blend control system 130, receives a signal to begin supplying the blend. In some embodiments, the signal may be measured as a pressure drop in the fuel composition supply system. In some embodiments, the blend control system may receive a signal from actuation of a valve at a nozzle or outlet of the fuel composition supply system. The fuel composition supply system may be actuated through a range of supply flow rates and the blend control system may receive a signal to control the supply of the blend accordingly. Alternatively, the extent of actuation of the fuel composition supply system may be determined by measuring the pressure of the fuel composition flowing in the fuel composition supply system.

Blend control system 130 may be a computerized control system and may include multiple modules and/or a central processing unit for controlling various aspects of the fuel dispensing system, including any one or all of controlling and accepting the customer inputs through the input system, controlling the display system, querying and interacting with the purchaser, controlling the blending of the various fuel components based on an input blend, calculating and controlling a blend price, payment options and authorization and payments, controlling safety components and controlling any other suitable equipment and devices. In some embodiments, blend control system 130 will evaluate the selected blend for compliance with one or more regulations or standards, such as one or more Department of Transportation (“DOT”) or Environmental Protection Agency (“EPA”), one or more ASTM standards or other Federal or State regulations and may prompt the consumer to select a different blend if the initially selected blend would not be compliant. Blend control system 130 may comprise or be implemented using any single or a combination of suitable processors and components and may include one or more ASICS, one or more general integrated circuits, one or more commercial off the shelf systems, a combination of hardware and software suitable for performing the various functions or may be implemented using a combination of peripheral devices and/or a combination of one or more of the above. It should be understood that one or more of the various functions described within the blend control system may be physically present within the one or more other systems rather than within a centralized blend control system. The various modules within blend control system 130 may be interconnected and may communicate with one or more other modules.

Conventional fuel component supply system 140 may include one or more conventional fuel component storage tanks, piping, tubing, valves, connections, other equipment and one or more pumps for supplying at least one conventional fuel component to the mixing system 160. The conventional fuel component supply system 140 may also include fluid flow sensors and other physical parameter sensors for ensuring accurate, safe and regulatory-compliant supply of the at least one conventional fuel components. In some embodiments the fluid flow sensors may feed back to the blend control system 130 for control of the pumps and/or control valves to ensure accurate supply of the selected blend and/or to calculate and/display an instantaneous price, which may be combined with the instantaneous prices of the other fuel components in the selected blend to arrive at a final price charged. For example the instantaneous prices may be averaged for each fuel component, or they may be integrated to arrive at an actual price for the total amount of each fuel component. The flow sensors may be any suitable sensor and may measure the volume or mass flow rate. In some embodiments, the flow sensor may be a mechanical flow meter, such as a venturi flow meter, a dall tube flow meter, an orifice plate flow meter, a Pitot tube flow meter, a paddle wheel flow meter, a radial turbine flow meter or an axial turbine flow meter. In other embodiments, the flow sensor may be a vortex flow meter, a magnetic flow meter, an ultrasonic flow meter or a coriolis flow meter. Examples of other physical parameters sensors that may be used may include vapor pressure sensors, viscosity sensors, density sensors, fuel rating sensors, environmental sensors or any other sensor needed to ensure compliance with the various DOT, EPA, Federal and State regulations and ASTM standards. The one or more pumps and/or one or more control valves may be controlled by the blend control system 130 to supply the at least one conventional fuel components in an amount based on the purchaser selected blend to the mixing system 160. In some embodiments, the one or more pumps may be positive displacement or rotodynamic pumps.

Similarly, second fuel component supply system 150 may include one or more second fuel component storage tanks, piping, tubing, valves, connections, other equipment and one or more pumps for supplying at least one second fuel component to the mixing system 160. The second fuel component supply system 150 may also include fluid flow sensors and other physical parameter sensors for ensuring accurate, safe and regulatory-compliant supply of the at least one second fuel components. In some embodiments the fluid flow sensors may feed back to the blend control system 130 for control of the pumps and/or control valves to ensure accurate supply of the selected blend and/or to calculate and/display an instantaneous price, which may be combined with the instantaneous prices of the other fuel components in the selected blend to arrive at a final price charged. For example the instantaneous prices may be averaged for each fuel component, or they may be integrated to arrive at an actual price for the total amount of each fuel component. The flow sensors may be any suitable sensor and may measure the volume or mass flow rate. In some embodiments, the flow sensor may be a mechanical flow meter, such as a venturi flow meter, a dall tube flow meter, an orifice plate flow meter, a Pitot tube flow meter, a paddle wheel flow meter, a radial turbine flow meter or an axial turbine flow meter. In other embodiments, the flow sensor may be a vortex flow meter, a magnetic flow meter, an ultrasonic flow meter or a coriolis flow meter. Examples of other physical parameters sensors that may be used may include vapor pressure sensors, viscosity sensors, density sensors, fuel rating sensors, environmental sensors or any other sensor needed to ensure compliance with the various DOT, EPA, Federal and State regulations and ASTM standards. The one or more pumps and/or one or more control valves may be controlled by the blend control system 130 to supply the at least one conventional fuel components in an amount based on the purchaser selected blend to the mixing system 160. In some embodiments, the one or more pumps may be positive displacement or rotodynamic pumps.

Mixing system 160 receives the one or more conventional fuel components and the one or more second fuel components and combines them into a fuel composition. In some embodiments, mixing system 160 may be a “T”, “X” or a “Y” connection or any other suitable connection for joining two or more fluid lines. In some embodiments, mixing system 160 may comprise a joining of the conventional fuel component and second fuel component supply lines into a single pipe or tube with the components flowing together or separately, or into a partitioned pipe or tube with the conventional fuel components and the second fuel components flowing in separate partitions. In some embodiments, mixing system 160 may be provided at the nozzle or outlet of the fuel composition supply system. For example, in some embodiments, after leaving the conventional and second fuel component supply systems, the conventional and second fuel components may be pumped in separate lines to the fuel composition supply system outlet where the may be combined into a single pipe or tube or where they may remain separate until leaving the fuel composition supply system and entering the inlet for the purchaser's storage container. In such cases, in some embodiments the purchase price may be calculated based on the volume or mass of flow measured by flow sensors in the conventional fuel component supply system and the second fuel component supply system rather than the volume or mass of flow of the fuel composition.

In some embodiments the mixing system may comprise an in-line static mixer wherein after being combined using a suitable joining connection the in-line static mixer forces the fuel composition through a line which promotes mixing of the fuel composition by redirecting layers of the fuel composition from flowing parallel to the direction of flow such that they are no longer flowing completely parallel to the direction of flow. Some embodiments of such a mixer include a length of pipe or tubing having turbulence promoters projecting into the flowing fuel composition from the wall of the pipe or tubing that may promote areas of turbulent mixing within the flowing fuel composition. In other embodiments, the mixer may comprise a powered mixer, such as a rotor-stator mixer or other powered mixer, that may physically mix the fuel component streams or the fuel composition stream and that may be controlled by the blend control system 130. In some embodiments, mixing system 160 may include a fluid flow sensor which may be any suitable sensor, such as a mechanical flow meter, such as a venturi flow meter, a dall tube flow meter, an orifice plate flow meter, a pitot tube flow meter, a paddle wheel flow meter, a radial turbine flow meter or an axial turbine flow meter. In other embodiments, the flow sensor may be a vortex flow meter, a magnetic flow meter, an ultrasonic flow meter or a coriolis flow meter.

Fuel composition supply system 170 may comprise a fuel composition flow sensor, which measures the instantaneous and cumulative fuel composition flow rates and communicates with the blend control system 130. In some embodiments, the flow sensor may be any suitable sensor, such as a mechanical flow meter, such as a venturi flow meter, a dall tube flow meter, an orifice plate flow meter, a Pitot tube flow meter, a paddle wheel flow meter, a radial turbine flow meter or an axial turbine flow meter. In other embodiments, the flow sensor may be a vortex flow meter, a magnetic flow meter, an ultrasonic flow meter or a coriolis flow meter. In addition, fuel composition supply system 170 may include a supply nozzle or outlet with a manual control valve that may be actuated by the purchaser to start, control and shutoff the flow of the fuel composition into the purchaser's storage container. In some embodiments, the supply nozzle communicates with the blend control system 130 to initiate, control and shutoff the supply of the fuel composition. In some embodiments, the supply nozzle communicates with the blend control system 130 by shutting off flow of the fuel composition, thereby creating a pressure change that may initiate shutoff of the blend control system. The pressure change may be measured by any suitable device, such as a pressure transducer.

In some embodiments, the supply nozzle may include an automatic shutoff control and an automatic fuel composition supply control. The automatic shutoff control may provide automatic shutoff of the fuel composition supply system and the blend control system to prevent overfilling of the purchaser's storage container. In some embodiments, the automatic shutoff control may comprise a small vacuum tube, such as a venture that runs down the nozzle and has an opening near the outlet end of the nozzle. The pumping fuel composition may produce suction on the vacuum tube and when the fuel composition gets high enough in the storage container to cover the end of the tube it increases the vacuum on the other end of the tube which may trip a mechanical shut-off The automatic fuel composition supply control may be a mechanical control that provides for automatic supply of the fuel composition and that shuts off in conjunction with or as a result of the automatic shutoff control. In other embodiments, the automatic fuel composition supply control may be an electronic or computer control that may supply the fuel composition and shutoff in conjunction with or as a result of the automatic shutoff control, or may be set to provide supply of a specific volume or cumulative price of the fuel composition. In some embodiments the fuel composition supply system may include additional sensors to measure various properties of the fuel composition, such as to verify that it is in compliance with DOT, EPA, ASTM and other Federal and State regulations and standards. The supply nozzle may be placed within the inlet line of the purchaser's storage container and may be actuated to supply the fuel composition into the purchaser's storage container. In some embodiments, the fuel composition supply system 170 may include a fluid supply line that may be securely connected directly or via an adapter to a storage container and may include an automatic shutoff control and/or an automatic supply control.

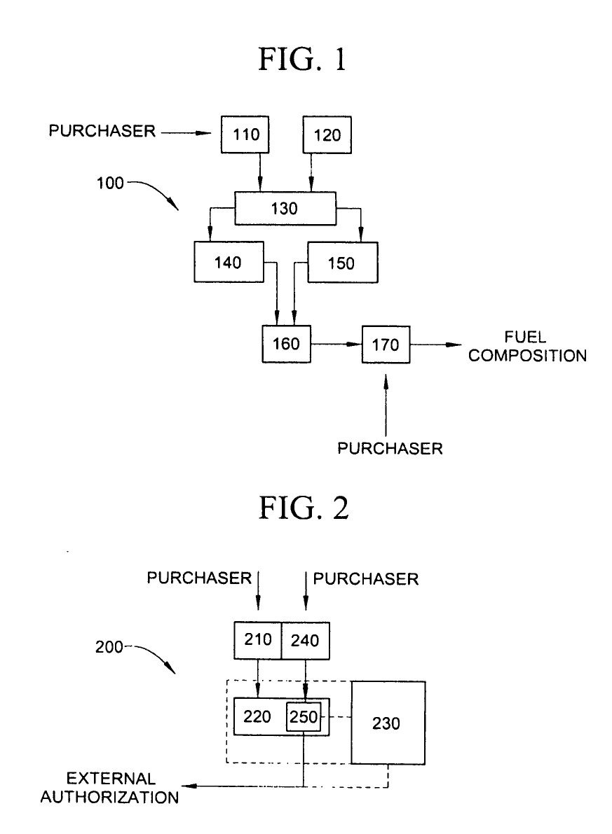

FIG. 2 is a detail block diagram of an embodiment of an input system 200. Input system 200 has a numeric keypad 210 which may also include multiple function keys and may be used to communicate with input module 220. Input module 220, which may be part of input system 200 or may be part of a blend control system 230, may accept information input by the customer and provide it to, the blend control system and the other portions of the fuel-dispensing system. A purchaser may select a payment type using numeric keypad 210, may scan a credit card, debit card or payment fob using a card reader or scanner or other suitable payment device 240, may enter a pin or authorization code using numeric keypad 210, and may select a desired fuel composition and blend of fuel components using numerical keypad 210 or a dial or other selection system (not shown). Input system 200 and input module 220 may include at least one payment type authorization system 250 which may communicate directly or via blend control system 230 with external debit card or credit card verification systems to authorize a selected payment type or may communicate with an external person or system, such as a gas station cashier, for authorization of the transaction. In some embodiments, the input system 200 may include one or more pre-selected blend keys. In some embodiments, a purchaser may have one or more pre-selected blends that are associated with a payment fob, such that scanning of the fob selects the blends desired by the purchaser or provides the pre-selected blends as options on the display.

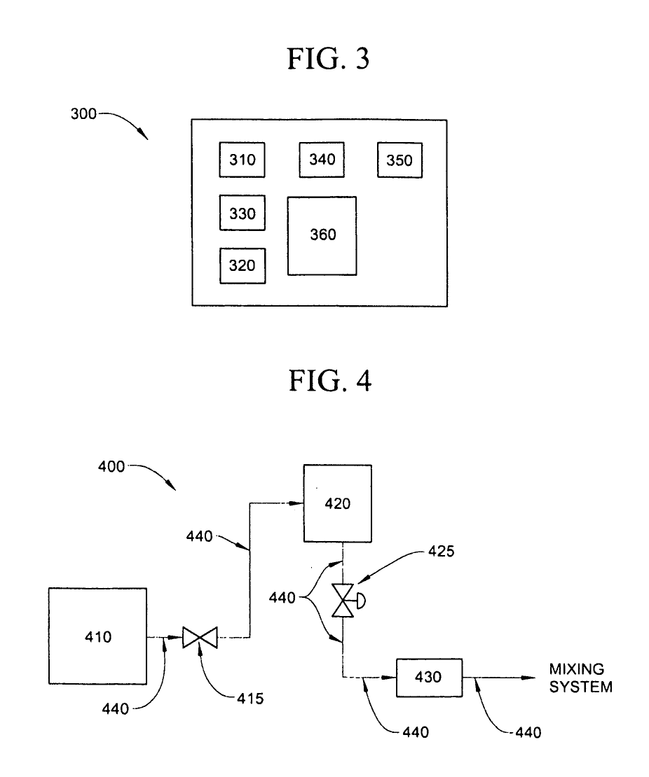

FIG. 3 is a block diagram of an embodiment of a blend control system 300. Blend control system 300 comprises input module 310, display module 320, authorization module 330, pricing module 340, fuel blend control module 350 and central processing unit (“CPU”) 360. In some embodiments, one or more of the modules may communicate directly with one or more other modules. In some embodiments, one or more of the modules communicate with the other modules through central processing unit 360. In some embodiments, there may be multiple interconnections between the various modules. Each of the modules may be implemented using one or more ASICS, one or more general integrated circuits, one or more commercial off the shelf systems, a combination of hardware and software suitable for performing the various functions or may be implemented using a combination of peripheral devices and/or a combination of one or more of the above and may be separate from the other modules or may be integrated as part of the blend control system.

In some embodiments, the blend control system 300 may include an off-the shelf microprocessor programmed to provide the various module functions alone or in combination with suitable hardware components and may include analog to digital converters, on board and/or external memory, microcontrollers, communications circuits and any other suitable equipment for achieving the various functions. Generally, blend control system 300 should not be considered to be limited to any specific configuration of components and may include additional modules to perform any additional functions such as monitoring of various physical parameter sensors. It should also be understood that the various functions associated with each module may be performed completely or in part by any other modules and may be performed completely or in part by the various hardware and other components.

Input module 310 receives information input by the customer including the selected blend, payment type and payment information and may communicate with the CPU 360, which may route the payment type and payment information to the authorization module 330, the entered information to the display module 320, and may route the selected blend information to the authorization system to verify compliance of the selected blend with the relevant DOT, EPA, ASTM or other Federal and State regulations and standards, to the fuel blend control module to provide for control of the conventional fuel component supply system and the second fuel component supply system to supply the selected blend and to the pricing module for calculation of the price of the selected blend.

Display module 320 controls the display and displays any information it is instructed to display based on communication with CPU 360 or with any of the other modules. In some embodiments, display module 320 may receive and display the information entered by the customer, may receive and display queries and other information for the customer from the central processing unit 360 such as queries to control the transaction or other queries or information, may receive and display the pricing information calculated in the pricing module, may receive and display conventional fuel component and second fuel component supply flow information may receive and display fuel composition flow information from the fuel composition supply system and may receive and display other information from any other sensors or from the various modules.

Authorization module 330 receives the payment type and payment information input by the purchaser and communicates with external verification and/or security systems to authorize payment for the transaction. In some embodiments, the authorization module 330 may communicate with a credit card or debit card verification or security system. In some embodiments, the authorization module 330 may communicate with a station cashier authorization system. Authorization module 330 may also receive blend selection information as input by the purchaser and may compare the selected blend and the physical and chemical characteristics of the selected blend with DOT, EPA, ASTM or other Federal and State regulations and standards based on information about the physical and chemical characteristics of the conventional and second fuel components selected for the blend for compliance and may provide compliance information to the CPU 360 for further use in controlling the transaction.

Pricing module 340 may receive the input selected fuel blend, may calculate a predicted price for the selected blend and may forward this predicted price to the CPU 360 and/or display module 320 for display to the purchaser and/or acceptance by the purchaser. Pricing module 340 may also receive cumulative and instantaneous fuel composition flow information from the fuel composition supply system, may calculate the cumulative and instantaneous price and may provide for its display to the customer. In some embodiments, the pricing module 340 receives flow information for the individual fuel components supplied and calculates and provides for display of an instantaneous and cumulative price based on this flow information. In some embodiments, the pricing module averages the individual instantaneous prices to use in calculating the cumulative price, in other embodiments, the pricing system calculates the cumulative price from the instantaneous prices and the instantaneous flow information, while in still other embodiments the pricing module calculates the cumulative price based on the predicted price and the cumulative or instantaneous flow information for the individual components or for the fuel composition.

Fuel blend control module 350 receives the input selected fuel blend and controls the fuel component supply systems to provide the various fuel components to the mixer in the selected proportions of conventional and second fuel components that make up the selected fuel blend. Fuel blend control module 330 may receive inputs and/or feedback from fuel component flow sensors, pumps and/or control valves, other physical parameter sensors and from the fuel composition supply system. The fuel blend control module 350 may control the supply of the fuel components by controlling pumps and/or control valves for each fuel component in the selected blend and may use proportional, proportional-integral or proportional-integral-derivative or any other control to achieve the desired blend by providing for pumping of the individual components to the mixer in the appropriate ratios. In addition, the fuel blend control module may communicate with the fuel composition supply system, may receive its initial instructions to begin pumping the blend based on actuation of the fuel composition supply system and may receive its instructions to stop pumping the blend based on deactivation of the fuel composition supply system.

Central processing unit (“CPU”) 360 may perform any of the tasks mentioned above as separate modules and may provide for inter-communication between the modules. In some embodiments, some or all of the input and output signals are routed through CPU 360 which then routes the information to the appropriate modules and equipment. In some embodiments, the CPU also provides queries to the purchaser to assist in conducting the transaction and provides for display of relevant information to the purchaser.

FIG. 4 is a block diagram of an embodiment of a conventional fuel component supply system 400. Conventional fuel component supply system 400 comprises one or more conventional fuel component storage tanks 410, one or more supply valves 415, one or more supply pumps 420, one or more control valves 425 and one or more flow sensors 430 in fluid communication with each other via piping and/or tubing 440. Though the following discussion is based on one conventional fuel component, it is contemplated that multiple conventional fuel components such as 2-10 conventional fuel components, such as 3, 4, 5, 6, 7, 8, or 9 conventional fuel components may be supplied using additional conventional fuel component supply systems according to embodiments of the invention with appropriate modifications to the control systems, valves, pumps, piping, flow sensors and other systems to allow for the additional conventional fuel components.

Conventional fuel component storage tank 410 may be any tank suitable for storage of the conventional fuel component and may include various equipment and sensors for filling, pressurization of the tanks and withdrawal of the conventional fuel component and for safe and regulatory-compliant storage of the conventional fuel component. In some embodiments conventional fuel storage tank 410 includes one or more of and any suitable combination of the following: level sensors, pressure relief valves, pressure transducers, environmental and safety monitoring and control sensors, supply and fill lines and connections, dip tubes, stirrers, valves, piping and other suitable equipment. In some embodiments, conventional fuel storage tank 410 comprises an underground storage tank.

Supply valve 415 may be a manually, pressure or electronically actuated valve and may be a control valve that is controlled by the blend control system or by any other system, such as a tank safety or tank supply system. Supply pump 420 may be any suitable pump for pumping the conventional fuel component, such as a positive displacement pump or a rotodynamic pump, may be a variable controlled pump or a constant flow pump and may be sized appropriate for the desired conventional fuel component and/or fuel composition flow rates. Supply pump 420 may be controlled by the blend control system based on the purchaser-selected blend to supply the conventional fuel component at the appropriate proportion. Such control may be proportional, proportional-integral or proportional-integral-derivative control and may include feedback control based on the fluid flow sensed using flow sensor 430. Flow sensor 430 may be any suitable fluid flow measurement sensor, such as a mechanical flow meter, such as a venturi flow meter, a dall tube flow meter, an orifice plate flow meter, a Pitot tube flow meter, a paddle wheel flow meter, a radial turbine flow meter or an axial turbine flow meter. In other embodiments, flow sensor 430 may be a vortex flow meter, a magnetic flow meter, an ultrasonic flow meter or a coriolis flow meter. Flow sensor 430 may measure the instantaneous and/or cumulative volumetric or mass flow of the conventional fuel component flowing through the piping 440 towards the mixing system and may supply this information to one or more modules of the blend control system.

In use, supply pump 420, and/or valve 415 and/or valve 425 receive signals from the blend control system initiating start-up and control of supply pump 420 and/or controlling the opening and closing and in some embodiments the extent of opening and closing of valve 415 and/or 425 based on the purchaser-selected blend and the selected proportion of the conventional fuel component in the fuel composition. The blend control system may receive feedback from flow sensor 430 to assist in controlling the amount of conventional fuel component supplied by supply pump 420. The blend control system may control the amount of the conventional fuel component supplied by controlling the speed of the supply pump 420 and/or the extent that valve 415 and/or valve 425 are opened or closed. Supply pump 420 is controlled to pump the desired amount of the conventional fuel component to the mixing system.

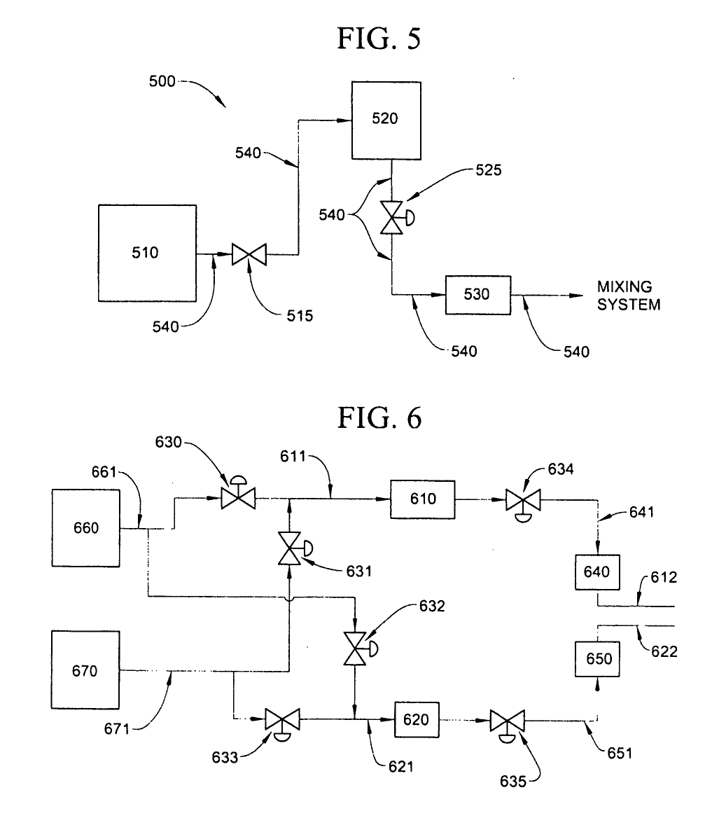

FIG. 5 is a block diagram of an embodiment of a second fuel component supply system 500. Second fuel component supply system 500 comprises one or more second fuel component storage tanks 510, one or more supply valves 515, one or more supply pumps 520, one or more control valves 525 and one or more flow sensors 530 in fluid communication with each other via piping and/or tubing 540. Though the following discussion is based on one second fuel component, it is contemplated that multiple second fuel components such as 2-10 second fuel components, such as 3, 4, 5, 6, 7, 8, or 9 second fuel components may be supplied using additional second fuel component supply systems according to embodiments of the invention with appropriate modifications to the control systems, valves, pumps, piping, flow sensors and other systems to allow for the additional second fuel components.

Second fuel component storage tank 510 may be any tank suitable for storage of the second fuel component and may include various equipment and sensors for filling, pressurization of the tank and withdrawal of the second fuel component from the tank and for safe and regulatory-compliant storage of the second fuel component. In some embodiments, second fuel storage tank 510 includes one or more of and any suitable combination of the following: level sensors, pressure relief valves, pressure transducers, environmental and safety monitoring and control sensors, supply and fill lines and connections, dip tubes, stirrers, valves, piping and other suitable equipment. In some embodiments, second fuel storage tank 510 comprises an underground storage tank.

Supply valve 515 may be a manually, pressure or electronically actuated valve and may be a control valve that is controlled by the blend control system or by any other system, such as a tank safety or tank supply system. Supply pump 520 may be any suitable pump for pumping the second fuel component, such as a positive displacement pump or a rotodynamic pump, may be a variable controlled pump or a constant flow pump and may be sized appropriate for the desired conventional fuel component and/or fuel composition flow rates. Supply pump 520 may be controlled by the blend control system based on the purchaser selector blend to supply the second fuel component at the appropriate proportion. Such control may be proportional, proportional-integral or proportional-integral-derivative control and may include feedback control based on the fluid flow sensed using flow sensor 530. Flow sensor 530 may be any suitable fluid flow measurement sensor, such as a mechanical flow meter, such as a venturi flow meter, a dall tube flow meter, an orifice plate flow meter, a Pitot tube flow meter, a paddle wheel flow meter, a radial turbine flow meter or an axial turbine flow meter. In other embodiments, flow sensor 530 may be a vortex flow meter, a magnetic flow meter, an ultrasonic flow meter or a coriolis flow meter. Flow sensor 530 may measure the instantaneous and/or cumulative volumetric or mass flow of the second fuel component flowing through the piping 540 towards the mixing system and may supply this information to one or more modules of the blend control system.

In use, the supply pump 520, and/or valve 515 and/or valve 525 receive signals from the blend control system initiating start-up and control of supply pump 520 and/or controlling the opening and closing and in some embodiments the extent of opening and closing of valve 515 and/or 525 based on the purchaser-selected blend and the selected proportion of the second fuel component in the fuel composition. The blend control system may receive feedback from flow sensor 530 to assist in controlling the amount of second component supplied by supply pump 520. The blend control system may control the amount of the second fuel component supplied by controlling the speed of the supply pump 520 and/or the extent that valve 515 and/or valve 525 are opened or closed. Supply pump 520 is controlled to pump the desired amount of the second fuel component to the mixing system.

FIG. 6 is a schematic showing an embodiment of a combined system 600 for supplying a conventional fuel component and second fuel component to the mixing system. Though the following discussion is based on one conventional fuel component and one second fuel component, it is contemplated that multiple conventional and second fuel components such as 2-10 conventional and/or second fuel components, such as 3, 4, 5, 6, 7, 8, or 9 conventional and/or second fuel components may be supplied by combining additional fuel component supply systems according to embodiments of the invention with appropriate modifications to the control systems, valves, pumps, piping, flow sensors and other systems to allow for the fuel components.

Combined system 600 includes major component pump 610, major component piping/tubing 611 and minor component pump 620, valves 630, 631, 632 and 633 and optionally valves 634 and 635, and flow sensors 640 and 650. The blend control system may determine which fuel component is the major component and which fuel component is the minor component based on the proportions of the conventional components and the second components in the selected blend and/or the desired fuel composition and may control the combined system 600 accordingly.

Specifically, when the major component is the conventional fuel component, the blend control system may actuate valve 630 to open and may ensure that valves 631 and 632 are closed and thereby create fluid communication between the major component pump 610 and the conventional fuel component storage tank 660. When initiated, major component pump 610 may withdraw the conventional fuel component from the storage tank through conventional fuel component supply line 661, through valve 630 and major component supply line 611 through the major component pump 610, optional control valve 634, flow sensor inlet 641 and flow sensor 640 into major component mixer inlet 612 and ultimately into the mixing system where it is blended with the minor component and sent through a fuel composition supply system into a purchaser's storage tank. When the conventional fuel component is the minor component, the blend control system may actuate valve 632 to open and ensure that valves 630 and 633 are closed and thereby create fluid communication between the minor component pump 620 and the conventional fuel component storage tank 660. When initiated, minor component pump 620 may withdraw the conventional fuel component from the storage tank through conventional fuel component supply line 661, through valve 632 and minor component supply line 621 through the minor component pump 620, optional control valve 635, flow sensor inlet 651 and flow sensor 650 and into minor component mixer inlet 622 and ultimately into the mixing system where it is blended with the major component and sent through a fuel composition supply system into a purchaser's storage container.

Similarly, when the second fuel component is the major component, the blend control system may actuate valve 631 to open and ensure that valves 633 and 630 are closed and thereby create fluid communication between the major component pump 610 and the second fuel component storage tank 670. When initiated, major component pump 610 may withdraw the second fuel component from the storage tank through second fuel component supply line 671, through valve 631 and major component supply line 611 through the major component pump 610, optional control valve 634, flow sensor inlet 641 and flow sensor 640 into major component mixer inlet 612 and ultimately into the mixing system where it is blended with the minor component and sent through a fuel composition supply system into a purchaser's storage tank. When the second fuel component is the minor component, the blend control system may actuate valve 633 to open and ensure that valves 631 and 632 are closed and thereby create fluid communication between the minor component pump 620 and the second fuel component storage tank 670. When initiated, minor component pump 620 may withdraw the second fuel component from the storage tank through second fuel component supply line 671, through valve 633 and minor component supply line 621 through the minor component pump 620, optional control valve 635, flow sensor inlet 651 and flow sensor 650 and into minor component mixer inlet 622 and ultimately into the mixing system where it is blended with the major component and sent through a fuel composition supply system into a purchaser's storage tank. It should be understood that the blend control system may control the various pumps and valves to ensure that the selected blend is supplied to the purchaser.

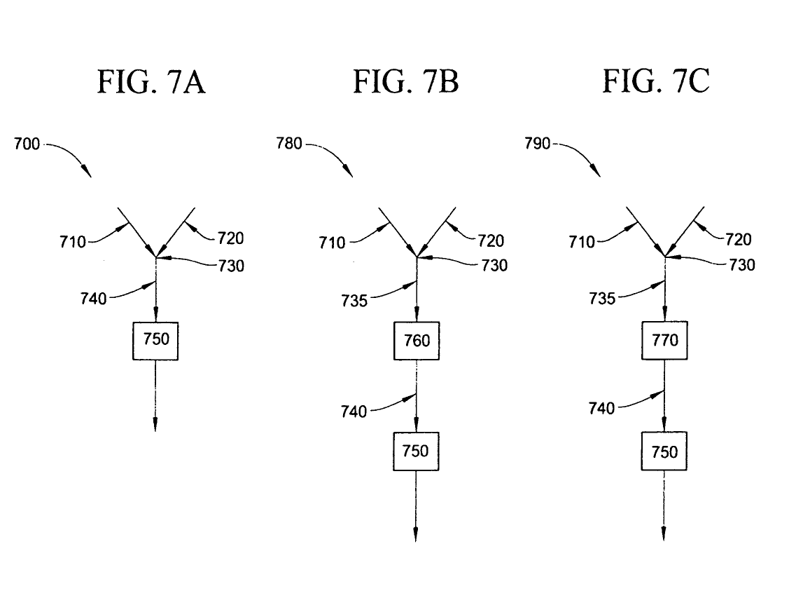

FIG. 7A is a schematic of an embodiment of a mixing system 700. Though the following discussion is based on one conventional fuel component and one second fuel component, it is contemplated that multiple conventional and second fuel components such as 2-10 conventional and/or second fuel components, such as 3, 4, 5, 6, 7, 8, or 9 conventional and/or second fuel components may be mixed by providing additional inlets to the mixer or additional mixers according to embodiments of the invention with appropriate modifications to the control systems, valves, pumps, piping, flow sensors and other systems to allow for the additional fuel components.

Mixing system 700 includes conventional fuel component inlet 710 and second fuel component inlet 720 which may be combined at junction 730, which may generally be a “T”, “X” or a “Y” junction or other suitably shaped junction or joining of two flowing fluid streams. In some embodiments, conventional fuel component inlet 710 and second fuel component inlet 720 may be joined to form a single new flow path 740. Alternatively, the pumping, valving and other supply components of the conventional fuel component supply system and the second fuel component supply system may be arranged such that the joining is accomplished by providing addition of the fuel component that is a minor proportion of the selected blend to be added to the line that includes the major component of the selected blend, with the major component line being the flow path 740. Flow path 740 connects the joined streams with flow sensor 750, which measures the flow rate of the fuel composition flowing through flow path 740 and provides the information to the blend control system and/or the conventional fuel component and second fuel component supply systems.

FIG. 7B is a schematic of an embodiment of a mixing system 780. Though the following discussion is based on one conventional fuel component and one second fuel component, it is contemplated that multiple conventional and second fuel components such as 2-10 conventional and/or second fuel components, such as 3, 4, 5, 6, 7, 8, or 9 conventional and/or second fuel components may be mixed by providing additional inlets to the mixer or additional mixers according to embodiments of the invention with appropriate modifications to the control systems, valves, pumps, piping, flow sensors and other systems to allow for the additional fuel components.

Mixing system 780 may include conventional fuel component inlet 710 and second fuel component inlet 720 which may be combined at junction 730 and which may feed the conventional fuel component and the second fuel component through mixer inlet 735 into in-line static mixer 760. Alternatively, conventional fuel component inlet 710 and second fuel component inlet 720 may join at, or the two components may be combined in, in-line static mixer 760. In-line static mixer 760 may include a series of geometric mixing elements fixed within a pipe, which may use the energy of the flow stream to create mixing of the conventional fuel components and the second fuel components. Such in line mixing may involve dividing the inflow stream and forcing it towards the walls of the pipe, which may result in a single direction mixing vortex that is axial to the centerline of the pipe. The mixing vortex subsequently may be sheared by one or more of the mixing elements causing the stream to be divided with the opposite directional rotation. In some embodiments, the in-line static mixer 760 comprises baffles placed within a pipe altering the direction of flow and thereby causing mixing and in some embodiments may include no moving parts. In some embodiments where the conventional fuel component inlet 710 and second fuel component inlet 720 enter the mixer separately, the mixing may be accomplished by directing the fluid flowing into mixer 760 from conventional fuel component inlet 710 and second fuel component inlet 720 in a direction that is, at least in part, along the inner wall of the pipe, such as in a direction tangent to the direction of flow, resulting in mixing of the components as they traverse the mixer and the pipe leading to the flow sensor. After leaving the in-line static mixer 760, the fuel composition flows into flow path 740 and through flow sensor 750 which measures the flow rate of the fuel composition and provides the information to the blend control system and/or the conventional fuel component and second fuel component supply systems.

FIG. 7C is a schematic of an embodiment of mixing system 790. Though the following discussion is based on one conventional fuel component and one second fuel component, it is contemplated that multiple conventional and second fuel components such as 2-10 conventional and/or second fuel components, such as 3, 4, 5, 6, 7, 8, or 9 conventional and/or second fuel components may be mixed by providing additional inlets to the mixer or additional mixers according to embodiments of the invention with appropriate modifications to the control systems, valves, pumps, piping, flow sensors and other systems to allow for the additional fuel components.

Mixing system 790 may include conventional fuel component inlet 710 and second fuel component inlet 720 which may be combined at junction 730 which may feed the conventional fuel component and the second fuel component through mixer inlet 735 and into in-line powered or dynamic mixer 770. Alternatively, conventional fuel component inlet 710 and second fuel component inlet 720 may join at, or the two components may be combined in, in-line powered or dynamic mixer 770. In-line powered or dynamic mixer 770 may be any suitable powered mixer and may have one or more mixing elements that are moved in a rotary motion about the axis of flow by a motor. In some embodiments, in-line powered mixer 770 may include one or more moving mixing elements and one or more stationary mixing elements, such as a rotor-stator mixer. After leaving the in-line static mixer 770, the fuel composition flows into flow path 740 and through flow sensor 750 which measures the flow rate of the fuel composition and provides the information to the blend control system and/or the conventional fuel component and bio-engineered fuel component supply systems.

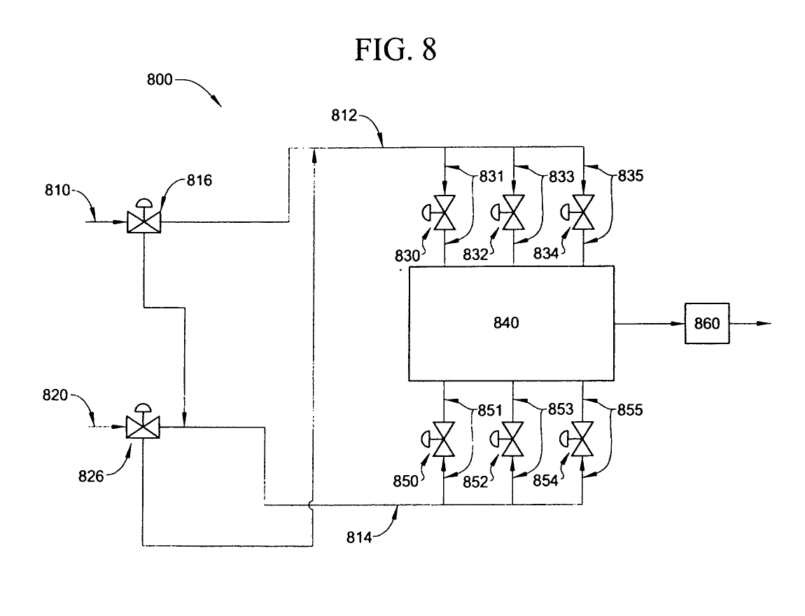

FIG. 8 is a schematic of a mixing system 800. Though the following discussion is based on one conventional fuel component and one second fuel component, it is contemplated that multiple conventional and second fuel components such as 2-10 conventional and/or second fuel components, such as 3, 4, 5, 6, 7, 8, or 9 conventional and/or second fuel components may be mixed by providing additional inlets to the mixer or additional mixers according to embodiments of the invention with appropriate modifications to the control systems, valves, pumps, piping, flow sensors and other systems to allow for the additional fuel components.

Mixing system 800 includes conventional fuel component inlet 810 and second fuel component inlet 820. A conventional fuel component flowing in conventional fuel component inlet 810 may be directed to major component flow line 812 or minor component flow line 814 by three way control valve 816. Three way control valve 816 may be controlled by blend controller to direct the conventional fuel component to the minor component flow line 814 or major component flow line 812 based on the proportion of the conventional fuel component in the selected blend. When the conventional fuel component is 50% or greater of the selected blend, i.e. is the major component, three way control valve 816 may be actuated by the blend control system to provide the conventional fuel component to the major component flow line 812, while when the conventional fuel component is less than 50% of the selected blend, i.e. is the minor component, three way control valve 816 may be actuated by the blend control system to provide the conventional fuel component to the minor component flow line 812.

Similarly, a second fuel component flowing in second fuel component inlet 820 may be directed to major component flow line 812 or minor component flow line 814 by three way control valve 826. Three way control valve 826 may be controlled by blend controller to direct the second fuel component to the minor component flow line 814 or major component flow line 812 based on the proportion of the second fuel component in the selected blend. When the second fuel component is 50% or greater of the selected blend, i.e. is the major component, three way control valve 826 may be actuated by the blend control system to provide the second fuel component to the major component flow line 812, while when the second fuel component is less than 50% of the selected blend, i.e. is the minor component, three way control valve 826 may be actuated by the blend control system to provide the second fuel component to the minor component flow line 812.

The fluid flowing in the major component flow line 812 (“the major component”), flows toward inlet valves 830, 832 and 834 and inlet piping 831, 833 and 835. The inlet valves 830, 832 and 834 and inlet piping 831, 833 and 835 may be sized to provide a pre-selected amount or range of amounts of the major component (as a percentage of the final fuel composition) and/or a pre-selected or range of pre-selected flow rates into the mixer 840. By way of example, inlet valve 830 and inlet piping 831 may be sized to supply the major component to the mixer in an amount such that the fuel composition includes from 50% to 70% by volume of the major component, while inlet valve 832 and inlet piping 833 may be sized to supply the major component to the mixer in an amount such that the fuel composition includes from 70% to 85% by volume of the major component and inlet valve 834 and inlet piping 835 may be sized to supply the major component to the mixer in an amount such that the fuel composition includes from 85% to 100% by volume of the major component. Though the instant figure shows three inlet valves and three inlet piping sets, the number and size of the inlet valves and inlet piping sets may be varied to include any number and size of inlet valves and inlet piping sets having appropriately divided supply ranges to supply 50% to 100% by volume of the major component based on the desired fuel composition and the selected blend. In some embodiments, the mixing system, independent of the minor component system may include from 2 to 10 major component inlet valves and piping sets, such as 2, 3, 4, 5, 6, 7, 8 or 9 major component inlet valves and piping sets. The major component supply portion of the mixing system may supply from 50%-100% by volume of the major component based on the desired fuel composition and the selected blend.

In operation, blend control system may control a pump from the conventional fuel component supply system or from the second component supply system and actuate the appropriate valves to supply the major component to major component line 812. Blend control system may then actuate or control the appropriately sized inlet valve to supply the major component in an amount based on the selected blend to the mixer 840, which may be an in-line static mixer, an in-line dynamic or powered mixer or a joining of the inlet flows, such as a “T” or a “Y”. In some embodiments, any excess major component flowing in major component line 822 may be recycled back to the appropriate storage tank.

Similarly, the fluid flowing in the minor component flow line 814 (“the minor component”), flows toward inlet valves 850, 852 and 854 and inlet piping 851, 853 and 855. The inlet valves 850, 852 and 854 and inlet piping 851, 853 and 855 may be sized to provide a pre-selected amount or range of amounts of the minor component (as a percentage of the final fuel composition) and/or a pre-selected or range of pre-selected flow rates into the mixer. By way of example, inlet valve 850 and inlet piping 851 may be sized to supply the minor component to the mixer in an amount such that the fuel composition includes from 1% to 15% by volume of the minor component, while inlet valve 852 and inlet piping 853 may be sized to supply the minor component to the mixer in an amount such that the fuel composition includes from 15% to 35% by volume of the minor component and inlet valve 854 and inlet piping 855 may be sized to supply the minor component to the mixer in an amount such that the fuel composition includes from 35% to 50% by volume of the minor component. Though the instant figure shows three inlet valves and three inlet piping sets, the number and size of the inlet valves and inlet piping sets may be varied to include any number and size of inlet valves and inlet piping sets having appropriately divided supply ranges to supply 1% to 50% by volume of the minor component based on the desired fuel composition and the selected blend. In some embodiments, the mixing system, independent of the major component system may include from 2 to 10 major component inlet valves and piping sets, such as 2, 3, 4, 5, 6, 7, 8 or 9 minor component inlet valves and piping sets. The minor component supply portion of the mixing system may supply from 1-50% by volume of the minor component based on the desired fuel composition and the selected blend.

In operation, the blend control system may control a pump from the conventional fuel component supply system or from the second component supply system and actuate the appropriate valves to supply the minor component to minor component line 814. Blend control system may then actuate or control the appropriately sized inlet valve to supply the minor component in an amount based on the selected blend to the mixer 840. In some embodiments, any excess minor component flowing in minor component line 814 may be recycled back to the appropriate storage tank.

It should be understood that the valves and sensors and various other components may be implemented in any suitable configuration and that the configurations discussed herein are only by way of example and should not be construed to limit the full scope of the invention.

In some embodiments, the various pumps that supply the fuel components may be controlled by “slaving” one pump to the other and controlling the non-slaved pump such that as the flow rate in the non-slaved pump changes, the flow rate in the slaved pump changes accordingly to ensure supply of the selected blend.

### Fuel Composition

The resulting fuel composition can range from 100% of the conventional fuel component to 100% of the second fuel component and any blend in between the two extremes.

In certain embodiments, the amount of the second fuel component in the final fuel composition is at least about 2%, at least about 3%, at least about 5%, at least about 10%, at least about 15%, at least about 30%, at least about 40%, at least about 50%, at least about 60%, at least about 70%, at least about 80%, or at least about 90%, based on the total weight or volume of the fuel composition. In other embodiments, the second fuel component is present in an amount of at most about 5%, at most about 10%, at most about 15%, at most about 20%, at most about 25%, at most about 30%, at most about 35%, at most about 40%, at most about 45%, at most about 50%, at most about 60%, at most about 70%, at most about 80%, or at most about 90%, based on the total weight or volume of the fuel composition. In further embodiments, the second fuel component is present in an amount from about 2% to about 99%, from about 2.5% to about 95%, from about 5% to about 90%, from about 7.5% to about 85%, from about 10% to about 80%, from about 15% to about 80%, from about 20% to about 75%, or from about 25% to about 75%, based on the total weight or volume of the fuel composition.

In other embodiments, the amount of the second fuel component in the fuel compositions may be from 0.5% to 99%, from 0.5% to 98%, from 1% to 97%, from 1% to 96%, from 2% to 95%, from 2% to 90%, from 3% to 85%, or from 5% to 80%, based on the total amount of the fuel composition. In certain embodiments, the amount of the second fuel component is more than 1%, more than 2%, more than 3%, more than 4%, more than 5%, more than 10%, more than 15%, more than 20%, more than 25%, more than 30%, more than 35%, more than 40%, more than 45%, more than 50%, more than 55%, more than 60%, more than 65%, more than 70%, more than 75%, more than 80%, more than 85%, more than 90% or more than 95%, based on the total amount of the fuel composition. In some embodiments, the amount is in wt. % based on the total weight of the fuel composition. In other embodiments, the amount is in vol. % based on the total volume of the fuel composition.

A convention fuel component is any petroleum derived fuel component. In some embodiments, the conventional fuel component comprises gasoline. In general, gasoline is a mixture of hydrocarbons whose boiling point is below about 200° C., obtained in the fractional distillation of petroleum. The hydrocarbon constituents in the boiling range of gasoline are generally those that have 4 to 12 carbon atoms in their molecular structure. Gasoline can vary widely in composition; even gasolines with the same octane number may be quite different. For example, low-boiling distillates with high (above 20%) aromatics contents can be obtained from some crude oils. The variation in aromatics content as well as the variation in the content of normal paraffins, branched paraffins, cyclopentanes, and cyclohexanes is dependent upon the characteristics of the petroleum feedstock, and influence the octane number of the gasoline.

In certain embodiments, the conventional fuel component comprises diesel. The American Society for Testing and Materials (ASTM) categorizes diesel fuels into three general groups. The need to categorize these fuels results from the varied uses of diesel engines, which are designed to operate efficiently on one of the standard diesel fuels.

No. 1-D is a light distillate, similar to kerosene, for engines where frequent load changes and speed changes (truck, tractor engines) are essential. This fuel has a flash point greater than 38° C., with a minimum cetane number of 40. This fuel is believed to be particularly suitable for cold-weather operation.

No. 2-D is a medium distillate fuel with a lower volatility and higher density than No. 1-D. This fuel finds use in heavier-duty engines, for example, railroad engines, which operate at uniform speeds but with heavier loads than encountered during the use of No. 1-D. The flash point is greater than 52° C. and the minimum cetane number is 40.

No. 4-D is a heavy distillate fuel with the highest density and lowest volatility of the three diesel fuels. It finds use in low- and medium-speed engines such as marine engines and electric power generation engines, which operate under sustained loads. The flash point is greater than 55° C. and the minimum cetane rating is 30.

The premium grade diesel fuels are those that meet or exceed either the National Conference on Weights and Measures (NCWM) or the Engine Manufacturers Association (EMA) premium diesel definition.

Generally, the diesel fuel is a complex mixture of thousands of individual compounds. Most of these compounds are C₁₀-C₂₂ hydrocarbons and are generally parrafins, naphthenes (cycloparaffins) and aromatics. Normal paraffins refer to alkanes (which are composed of hydrogen and carbon) with a straight carbon chain.

Diesel fuel generally has a distillation range from 390 to 715° F. (from 200 to 380° C.) at 1 atmospheric pressure and a specific gravity range from 0.760 to 0.935. In addition to these properties, diesel fuel should have <1 wt. % of sulfur, <0.1 wt. % of ash, <0.5 vol. % of water and sediment, and a flash point greater than 55° C.

Diesel fuel quality can be characterized by the cetane number, which usually falls into the range from 30 to 60. A high cetane number indicates the potential for easy starting and smooth operation of the engine. The cetane number is the analog of the automobile engine octane number, with cetane (n-hexadecane, C₁₆H₃₄) having the arbitrarily assigned number of 100. At the other end of the scale, heptamethylnonane, an isomer of cetane, has the assigned cetane number of 0. The cetane number of a diesel fuel is determined by comparison with blends of cetane and heptamethylnonane. It corresponds to the number of parts by volume of cetane in a cetane-heptamethylnonane blend which has the same ignition quality as the fuel.

Generally, regular diesel fuels have an aromatic content above 20 wt. % and a sulfur content of several hundred parts per million or more. They may further include additional oxygen and/or nitrogen impurities. To obtain the desired diesel fuel, a regular diesel fuel undergoes a conversion step in which the aromatic hydrocarbons present in the regular diesel fuel are converted to non-aromatic hydrocarbons, such as cycloparaffins. This is typically achieved by hydrogenating the regular diesel fuel in the presence of a hydrogenation catalyst. Other conversion processes may also be used.

Ordinarily, “straight run” diesel fuel produced by simple distillation of crude oil is fairly low in aromatic hydrocarbons. Catalytic cracking of residual oil to increase gasoline and diesel production, however, results in increased aromatic content. A typical straight run diesel might contain from 20 to 25% aromatics by volume, while a diesel blended from catalytically cracked stocks could have from 40 to 50% aromatics. Aromatic hydrocarbons have poor self-ignition qualities, so that diesel fuels containing a high fraction of aromatics tend to have low cetane numbers. Typical cetane values for straight run diesel are in the range of from 50 to 55; those for highly aromatic diesel fuels are typically from 40 to 45, and may be even lower. This may cause more difficulty in cold starting and increased combustion noise due to the increased ignition delay.

In certain other embodiments, the conventional fuel component comprises jet fuel. The most common jet fuel is a kerosene/paraffin oil-based fuel classified as Jet A-1, which is produced to an internationally standardized set of specifications. In the United States only, a version of Jet A-1 known as Jet A is also used. Another jet fuel that is commonly used in civilian aviation is called Jet B. Jet B is a lighter fuel in the naptha-kerosene region that is used for its enhanced cold-weather performance. Jet A, Jet A-1 and Jet B are specified in ASTM Specification D. 1655-68. Alternatively, jet fuels are classified by militaries around the world with a different system of JP numbers. Some are almost identical to their civilian counterparts and differ only by the amounts of a few additives. For example, Jet A-1 is similar to JP-8 and Jet B is similar to JP-4. Alternatively, jet fuels can also be classified as kerosene or naphtha-type. Some non-limiting examples of kerosene-type jet fuels include Jet A, Jet A1, JP-5 and JP-8. Some non-limiting examples of naphtha-type jets fuels include Jet B and JP-4.

Jet A is the standard jet fuel type in the U.S. since the 1950s. Jet A is similar to Jet-A1, except for its higher freezing point of −40° C. Like Jet A-1, Jet A has a fairly high flash point of minimum 38° C., with an autoignition temperature of 210° C.

In some embodiments, the second fuel component comprises a C₁-C₂₀ alcohol. The C₁-C₂₀ alcohol may be linear or branched. In certain embodiments, the C₁-C₂₀ alcohol is a C₁ to C₂₀ aliphatic monoalcohols. In other embodiments, the C₁-C₂₀ alcohol comprises an aliphatic primary monoalcohol, such as methanol, ethanol, propanol, butanol, pentanol, hexanol, heptanol, octanol, nonanol, decanol, undecanol, dodecanol, tridecanol, myristyl alcohol, pentadecanol, palmityl alcohol, heptadecanol, stearyl alcohol, nonadecanol, arachidyl alcohol or a blend or combination of one or more thereof. In certain other embodiments, the C₁ to C₂₀ alcohol is also a biofuel.

In some embodiments, the second fuel component may include a fuel derived from a Fischer-Tropsch (“FT”) process. In some embodiments, the FT process may produce fuel components using natural gas, coal, biomass and/or organic waste, including biomass and/or coal gasification processes. The FT process generally may include any suitable FT fuel component production process and may include production of fuel components from the catalytic hydrogenation of carbon monoxide.

In some embodiments, the second fuel component is a biofuel. In contrast to non-renewable energy sources such as petroleum and coal, biofuels are derived from natural, renewable sources, typically from living or recently living organisms and their metabolic byproducts. In certain embodiments, the biofuel is ethanol. In certain other embodiments, the biofuel is butanol.

In some embodiments, the second fuel component comprises a fatty acid alkyl ester. In certain embodiments, the fatty acid alkyl ester is a fatty C₁ to C₁₅, C₁ to C₁₀, C₁ to C₈ or C₁ to C₆ alkyl esters. In certain other embodiments, the fatty acid alkyl ester is a fatty acid ethyl ester. In still other embodiments, the fatty acid alkyl ester is a fatty acid methyl ester (which is also known as biodiesel). In certain embodiments, the fatty acid alkyl ester is also a biofuel.

Generally, such fatty acid alkyl esters may be manufactured using transesterification of glycerides, such as tri-, di- and monoglycerides that are derived from animal or vegetable sources such as from vegetable oils or animal fats, with an alcohol, such as an aliphatic alcohol, such as an aliphatic monoalcohol, such as methanol or ethanol or any other suitable alcohol. Such transesterification may be accomplished using any suitable method, such as the method in U.S. Pat. No. 7,138,536, the entire content of which is incorporated herein by reference. In some embodiments, the vegetable oil may comprise a mixture of the oils and methanol. While soybean oil is the largest source of biodiesel, oils from other plants or animal fats can be the source materials, such as rape-seed oil, palm oil, sunflower oil, coconut oil, castor oil or any other vegetable oil or suet. In some embodiments, the second fuel component is a bio-engineered fuel. In certain embodiments, the bio-engineered fuel is an isoprenoid. In certain other embodiments, the bio-engineered fuel is a C₁₅ isoprenoid. In still other embodiments, the bioengineered fuel is farnesane:

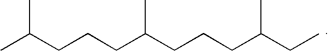

The fuel compositions disclosed herein can be used to power any equipment such as an emergency generator or internal combustion engine, which requires a fuel such as diesel fuels or jet fuels. The term “emergency fuel” refers to a fuel which is generally stored in a container other than the gas tank of a vehicle. The fuel should be stable over an extended period of time, for example, six to twelve months. When the vehicle runs out of fuel, the emergency fuel is added to the gas tank of the vehicle and provides fuel to the vehicle. Because the flash point of the diesel fuel made in accordance with embodiments of the invention generally exceeds 140° F., it can be safely stored in the trunk of a diesel vehicle. The fuel compositions can also be used as an alternative fuel as described in U.S. Pat. No. 6,096,103, which is incorporated by reference herein in its entirety.

While the invention has been described with respect to a limited number of embodiments, the specific features of one embodiment should not be attributed to other embodiments of the invention. No single embodiment is representative of all aspects of the invention. In some embodiments, the compositions or methods may include numerous compounds or steps not mentioned herein. In other embodiments, the compositions or methods do not include, or are substantially free of, any compounds or steps not enumerated herein. Variations and modifications from the described embodiments exist. The appended claims intend to cover all such variations and modifications as falling within the scope of the invention.

All publications and patent applications mentioned in this specification are herein incorporated by reference to the same extent as if each individual publication or patent application was specifically and individually indicated to be incorporated by reference. To the extent than any of the references incorporated herein conflict with the specific disclosure herein, the specific disclosure herein is controlling for purposes of understanding the conflicting material. Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

### EXAMPLES

In the following examples, efforts have been made to ensure accuracy with respect to numbers used (for example, amounts, temperature, and so on), but variation and deviation can be accommodated, and in the event a clerical error in the numbers reported herein exists, one of ordinary skill in the arts to which this invention pertains can deduce the correct amount in view of the remaining disclosure herein. Unless indicated otherwise, temperature is reported in degrees Celsius, and pressure is at or near atmospheric pressure at sea level. All reagents, unless otherwise indicated, were obtained commercially. The following examples are intended for illustrative purposes only and do not limit in any way the scope of the present invention.

### Example 1

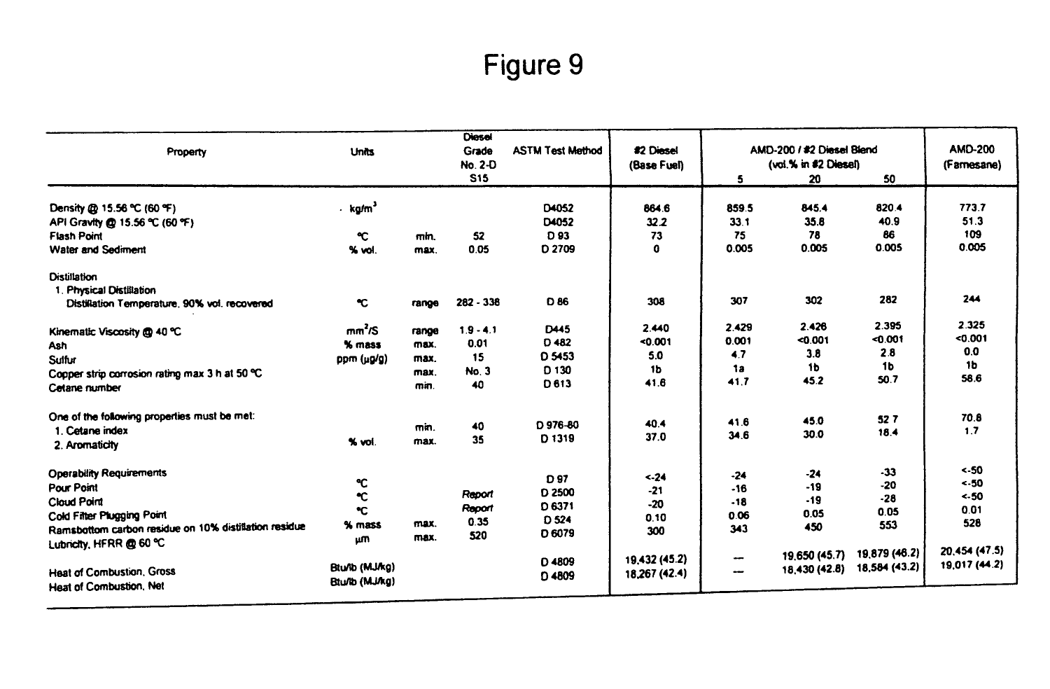

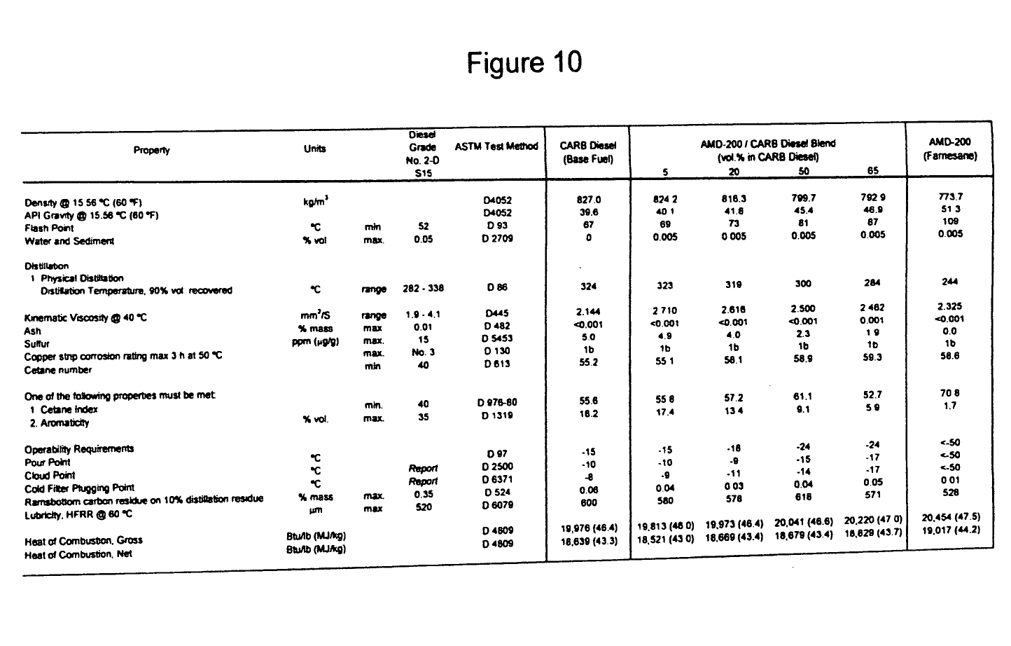

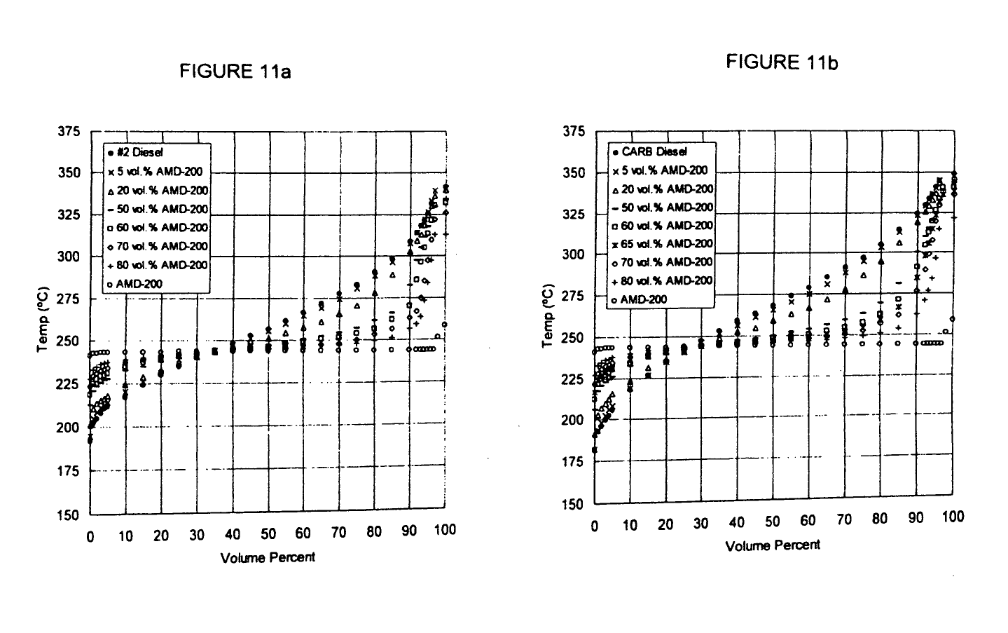

This example describes the testing of various amounts of farnesane with ultra low sulfur diesel obtained from either the BP Refinery in Whitting, Ind. or the BP Refinery in Carson, Calif. The diesel from the BP Carson Refinery is a CARE fuel which meets the requirements of the California Air Resources Board for use in California. Although lubricity agents are typically added to CARB fuel at the refinery, this sample of CARE fuel was obtained prior to any lubricity agents being added. FIGS. 9 and 10 show the test data of various amounts of farnesane blended with the diesel fuels from the refineries. FIGS. 11A-B show the distillation profiles of the various fuels and blends tested.

### Example 2

This example describes the determination of the amount of farnesane that is found naturally in petrodiesel, a complex mixture of thousands of individual compounds. Most of these compounds are C₁₀-C₂₂ hydrocarbons and are generally parrafins, naphthenes and aromatics.

Diesel samples were diluted in hexanes and then measured by GC-MS as described by Zielinska et al., J. Air & Waste Manage. Assoc. 54: 1138-1150 (2004). Table 1 shows the results in ug/mL, wt. % and vol. %.

TABLE 1

| | | Diluted | | Final Concentration | | |
|---|---|---|---|---|---|---|
| | Density | Concentration | Dilution | of Farnesane in Sample | | |
| Sample (Source) | (g/mL) | (μg/mL) | Factor | (μg/mL) | (wt. %) | (vol. %) |
| Farnesane standard | 0.7737 | | | | | |
| #2 Diesel (Chardon) | 0.8420 | 12.488 | 220 | 2747.36 | 0.33 | 0.36 |
| #2 Diesel (Sunoco 90 & 44) | 0.8430 | 8.642 | 220 | 1901.24 | 0.23 | 0.25 |
| #2 Diesel (BP 90 & 44) | 0.8310 | 14.772 | 220 | 3249.84 | 0.39 | 0.42 |
| #2 Diesel (Speedway Rt. 306 & Rt. 2) | 0.8410 | 13.497 | 220 | 2969.34 | 0.35 | 0.38 |
| #2 Diesel (Chardon) | 0.8300 | 15.362 | 220 | 3379.64 | 0.41 | 0.44 |
| #2 Diesel (Speedway Rt. 306 & Rt. 2) | 0.8434 | 13.770 | 220 | 3029.40 | 0.36 | 0.39 |
| #2 Diesel (BP Whiting, IN) | 0.8555 | 10.977 | 220 | 2414.87 | 0.28 | 0.31 |
| CARB Diesel (BP Carson, CA) | 0.8170 | 18.008 | 220 | 3961.76 | 0.48 | 0.51 |

Except for the last two samples in Table 1, all diesel samples were fuel purchased from gas stations selling diesel fuel. The No. 2 diesel from Whiting is from the BP Whiting Refinery. The CARB diesel is from the BP Carson Refinery and contains no lubricity enhancers.

### Example 3

This example describes addition of a lubricity enhancer to blends of farnesane with either diesel from the BP Whiting Refinery or the CARE diesel from the BP Carson Refinery.

The diesel fuel from the BP Whiting Refinery includes 200 ppm of Infinium R696 lubricity enhancer (previously known as ECD-1). An additional 100 ppm was added to the base fuel and the 5 vol. %, 20 vol. % and 50 vol. blends of farnesane with the base fuel was tested for lubricity according to ASTM D 6079. The resulting lubricity (HFRR@60° C.) for the 5 vol. %, 20 vol. %, and 50 vol. % blends were: 300 μm; 240 μm; and 450 μm respectively.

The CARB diesel from the BP Carson refinery contained no lubricity additive. 300 ppm of Infinium R696 was added to the base fuel, and the 5 vol. %, 20 vol. %, 50 vol. % and 65 vol. % blends of farnesane with the base fuel was tested from lubricity according to ASTM D 6079. The resulting lubricity (HFRR@60° C.) for the 5 vol. %, 20 vol. %, 50 vol. %, and 65% blends were: 200 μm; 240 μm; 280 μm; and 240 μm respectively.

1. A fuel composition-dispensing system comprising:
at least one input system;
at least one conventional fuel component supply system;
at least one second fuel component supply system;
at least one mixer;
wherein the mixer mixes at least one conventional fuel component received from the conventional fuel component supply system with at least one second fuel component received from the second fuel component supply to form a fuel composition based on a blend selected using the input system.

2. The system according to claim 1 wherein the conventional fuel component comprises a fuel is selected from the group consisting of gasoline, diesel and jet fuel.

3. The system according to claim 1, wherein the second fuel component comprises a fuel is selected from the group consisting of a Fischer-Tropsch fuel, a C₁-C₂₀ alcohol, a fatty acid alkyl ester and a bio-engineered fuel.

4. The system according to claim 1, wherein the second fuel component comprises ethanol.

5. The system according to claim 1, wherein the second fuel component comprises butanol.

6. The system according to claim 1, wherein the second fuel component comprises a fatty acid methyl ester.

7. The system according to claim 1, wherein the second fuel component comprises an isoprenoid.

8. The system according to claim 1, wherein the second fuel component comprises farnesane.

9. The system according to claim 1, wherein the second fuel component comprises a Fischer-Tropsch fuel.

10. The system according to claim 1, wherein the at least one conventional fuel component supply system includes at least one conventional component supply system pump and at least one conventional component flow sensor.

11. The system according to claim 10, wherein the at least one conventional component supply system pump comprises a positive displacement pump.

12. The system according to claim 10, wherein the at least one conventional component flow sensor comprises a mechanical flow sensor.

13. The system according to claim 1, wherein the at least one second fuel component supply system includes at least one second component supply system pump and at least one second component flow sensor.

14. The system according to claim 13, wherein the at least one second component supply system pump comprises a positive displacement pump.

15. The system according to claim 13, wherein the at least one second component flow sensor comprises a mechanical flow sensor.

16. The system according to claim 1, wherein the mixer comprises an in-line static mixer.

17. The system according to claim 1, further comprising a blend control system.

18. The system according to claim 17, wherein the blend control system controls the flow of the at least one conventional fuel component and a flow of the at least one second fuel component into the mixer based on the inputted blend.

19. The system of claim 18, wherein the blend control system controls the flow of the at least one conventional fuel component and the flow of the at least one second fuel component by controlling the at least one conventional component supply system pump and the at least one second component supply system pump.

20. A method of supplying a fuel composition comprising:
receiving a selected fuel blend from a purchaser through an input system, the blend comprising at least one conventional fuel component and at least one second fuel component;
receiving a demand for supply of a fuel composition based on the selected blend from a fuel composition supply system;
controlling at least one conventional fuel component supply system and at least one second fuel component supply system to supply the at least one conventional fuel component and the at least one second fuel component to a mixer based on the selected blend;
mixing the at least one conventional fuel component and the at least one second fuel component to form a fuel composition; and
supplying the fuel composition to a storage container.

21-45. (canceled)
